(19) United States
(12) Patent Application Publication
(10) Pub. No.: US 2024/0182352 A1
(43) Pub. Date: Jun. 6, 2024

(54) METHODS OF REGENERATING POISONED MOLTEN SALT BATHS WITH GLASS AND ASSOCIATED GLASS COMPOSITIONS

(71) Applicant: CORNING INCORPORATED, CORNING, NY (US)

(72) Inventors: Qiang Fu, Painted Post, NY (US); Yuhui Jin, Painted Post, NY (US); William James McKendrick, Painted Post, NY (US); Cedrick Alexander O’Shaughnessy, Painted Post, NY (US); Wei Sun, Painted Post, NY (US)

(21) Appl. No.: 18/386,292

(22) Filed: Nov. 2, 2023

Related U.S. Application Data
(60) Provisional application No. 63/428,281, filed on Nov. 28, 2022.

(51) Int. Cl. C03C 3/085

(52) U.S. Cl. CPC C03C 3/085; C03C 21/002

(57) ABSTRACT

A method of regenerating a lithium-poisoned molten salt bath is provided. The method includes contacting glass particulates with the molten salt bath such that poisoning ions are exchanged from the bath into the glass. The glass compositions utilized in the method are also provided.

This application claims the benefit of priority under 35 U.S.C. § 119 of U.S. Provisional Application Ser. No. 63/428,281 filed on Nov. 28, 2022, the content of which is relied upon and incorporated herein by reference in its entirety.

### BACKGROUND

### Field

The present specification generally relates to methods of regenerating poisoned molten salt baths. More specifically, the present specification is directed to methods of regenerating lithium-poisoned molten salt baths with a bath-regenerating sodium-containing glass-based composition.

### Technical Background

For many ion-exchanged glass-based goods, including recent generations of Corning's Gorilla product lines, an ion-exchange process is often used to strengthen Li₂O-containing glass or glass-ceramic articles. In this process, a glass-based (glass or glass-ceramic) article containing Li₂O is immersed in a molten salt bath containing at least one larger alkali metal cation, often K and/or Na. The smaller lithium cations diffuse from the glass surface into the salt bath while larger alkali metal cations from the salt bath replace the smaller cations in the surface of the glass. This substitution of larger cations for smaller cations in the glass-based article generates a layer of compressive stress layer on the surface of the glass, thus increasing the mechanical performance of the glass. As a result of the ion exchange, Li ions accumulate in the in the molten salt bath. For later batches of ion exchange, the accumulated Li ion concentration may result in undesired stress profile in glass or glass-ceramics, produce a lower CS and shallower DOL, and create surface defects, and/or impact the mechanical performance of the glass-based article. Current regeneration methods to reduce lithium poisoning based on the use of inorganics salts contain phosphate, carbonate, borate, or silicate, and are not compatible for lithium recycling. At the end of the process, such inorganic salts are disposed as a sludge layer along with nitrate salts, making it difficult, if not impossible, to recycle the lithium in the salts.

Some earlier generations of ion-exchanged glass-based goods used Na as the smaller cation in the ion exchange process, and K as the larger cation. In more recent generations, Li is the preferred smaller cation in the ion-exchange process. Lithium presents the highest sublimation energy, electronegativity and ionization energy and the smallest ionic radius for the alkali groups which entails a high charge density for lithium ions. Lithium is extracted primarily from lithium carbonate, which is used in glass and ceramics applications, and as cathode material for lithium ion batteries. Lithium metal is widely used as a chemical intermediate in many reactions including batteries. According to the U.S. Geological Survey, batteries and ceramic and glass are the most relevant end-use market for lithium. Over the last ten years, the lithium use in batteries is increasing rapidly, and accounts more than 50% of lithium usage in 2019. Lithium can be extracted from both brine and hard rock ores, with the latter having highest impact due to its simpler extraction process. Pegmatite ores, aluminum silicate deposits, containing minerals such as spodumene (Li₂O·Al₂O₃·4SiO₂), petalite (Li₂O·Al₂O₃·8SiO₂), lepidolite (K₂O·LI₂O·Al₂O₃·3SiO₂·(OH,F)₃) and amblygonite (Li₂O·Al₂O₃·2[PO+][F,OH], are the main source of lithium supplies.

Due to increasing use of lithium in electric vehicles, lithium pricing has been on a rapid rise over the past 20 years. Given the large amount of lithium used in certain ion-exchanged glass-based materials glasses, both in the glass composition and in the finishing steps, it is desirable to recycle lithium for further utilization.

Accordingly, a need exists for molten salt bath regeneration processes that have regeneration efficiency, do not result in surface defects on the glass articles produced from the bath, allow for the simple cleaning of the bath tanks, and allow for recovery of lithium.

### SUMMARY

According to aspect (1), a method is provided. The method comprises: contacting a glass-based bath regenerating material with a molten salt bath, wherein: prior to contacting, the glass-based bath regenerating material comprises:
greater than or equal to 30.0 mol. % and less than or equal to 85.0 mol. % SiO₂;
greater than or equal to 2.0 mol. % and less than or equal to 20.0 mol. % Al₂O₃;
greater than or equal to 10.0 mol. and less than or equal to 60.0 mol. % Na₂O;
greater than or equal to 0.0 mol. % and less than or equal to 3.0 mol. % K₂O;
greater than or equal to 0.0 mol. % and less than or equal to 10.0 mol. % MgO;
greater than or equal to 0.0 mol. % and less than or equal to 10.0 mol. % CaO; and
greater than or equal to 0.0 mol. % and less than or equal to 10.0 mol. % SrO; and
   the molten salt bath comprises poisoning ions, the poisoning ions comprising lithium ions; waiting a period of time during which the first glass-based article is in contact with the molten salt bath; after waiting the period of time, removing the glass-based bath regenerating material from the molten salt bath; wherein: after removing, the concentration of poisoning ions in the molten salt bath is less than the concentration prior to the contacting and the composition of the glass-based bath regenerating material has a higher amount of Li₂O than prior to contacting.

In aspect (2), in the method of aspect (1), prior to contacting, the glass-based bath regenerating material comprises CaO+6*SrO greater than or equal to 1.0 mol %.

In aspect (3), in the method of any of aspects (1) through (2), prior to contacting, the glass-based bath regenerating material comprises CaO+6*SrO greater than or equal to 1.5 mol %.

In aspect (4), in the method of any of aspects (1) through (3), prior to contacting, the glass-based bath regenerating material comprises CaO+6*SrO greater than or equal to 5.0 mol %.

In aspect (5), in the method of any of aspects (1) through (4), prior to contacting, the glass-based bath regenerating material comprises Li₂O less than or equal to 1 mol %.

In aspect (6), in the method of any of aspects (1) through (5), prior to contacting, the glass-based bath regenerating material is substantially free of Li₂O.

In aspect (7), in the method of any of aspects (1) through (6), prior to contacting, the glass-based bath regenerating material comprises MgO less than or equal to 3 mol %.

In aspect (8), in the method of any of aspects (1) through (7), prior to contacting, glass-based bath regenerating material comprises SiO₂ less than or equal to 50 mol %.

In aspect (9), in the method of any of aspects (1) through (8), prior to contacting, the glass-based bath regenerating material comprises Na₂O greater than or equal to Al₂O₃.

In aspect (10), in the method of any of aspects (1) through (9), prior to contacting, the glass-based bath regenerating material has a glass-transition temperature Tg greater than or equal to 470° C. and less than or equal to 530° C.

In aspect (11), in the method of any of aspects (1) through (10), the molten salt bath comprises one or more of potassium ions and sodium ions.

In aspect (12), in the method of any of aspects (1) through (11), the molten salt bath comprises one or more of KNO₃ and NaNO₃.

In aspect (13), in the method of any of aspects (1) through (12), the molten salt bath comprises:
greater than or equal to 3.0 wt. % and less than or equal to 97.0 wt. % KNO₃, and
greater than or equal to 3.0 wt. % and less than or equal to 97.0 wt. % NaNO₃, and

In aspect (14), in the method of any of aspects (1) through (13), the molten salt bath comprises:
greater than or equal to 5.0 wt. % and less than or equal to 95.0 wt. % KNO₃, and
greater than or equal to 5.0 wt. % and less than or equal to 95.0 wt. % NaNO₃, and

In aspect (15), in the method of any of aspects (1) through (14), the molten salt bath comprises:
greater than or equal to 20.0 wt. % and less than or equal to 80.0 wt. % KNO₃, and
greater than or equal to 20.0 wt. % and less than or equal to 80.0 wt. % NaNO₃, and

In aspect (16), in the method of any of aspects (1) through (15), the molten salt bath comprises:
greater than or equal to 40.0 wt. % and less than or equal to 60.0 wt. % KNO₃, and
greater than or equal to 40.0 wt. % and less than or equal to 60.0 wt. % NaNO₃, and

In aspect (17), in the method of any of aspects (1) through (16), the period of time extends for a period of from greater than or equal to 0.5 hours to less than or equal to 30 hours.

In aspect (18), in the method of any of aspects (1) through (17), the period of time extends for a period of from greater than or equal to 0.5 hours to less than or equal to 80 hours.

In aspect (19), in the method of any of aspects (1) through (18), after removing, the lithium poisoning ion is contained in the molten salt bath in an amount of less than or equal to 50% of the amount of the poisoning ion in the molten salt bath prior to contacting.

In aspect (20), in the method of any of aspects (1) through (19), the glass-based bath regenerating material comprises a plurality of particles having an average particle size from greater than or equal to 50 μm to less than or equal to 5 mm.

In aspect (21), in the method of any of aspects (1) through (20), the contacting comprises adding the plurality of particles directly to the molten salt bath.

In aspect (22), in the method of any of aspects (1) through (21), the contacting comprises placing the plurality of particles in a containment vessel during the contacting.

In aspect (23), in the method of any of aspects (1) through (22), during the period of time the molten salt bath has a temperature of greater than or equal to 350° C. to less than or equal to 550° C.

In aspect (24), in the method of any of aspects (1) through (23), during the period of time the molten salt bath has a temperature of greater than or equal to 450° ° C. to less than or equal to 550° C.

In aspect (25), in the method of any of aspects (1) through (24), during the period of time the molten salt bath has a temperature of greater than or equal to 470° C. to less than or equal to 550° C.

In aspect (26), in the method of any of aspects (1) through (25), the amount of glass-based bath regenerating material contacted with the molten salt bath is greater than or equal to 0.5 wt % to less than or equal to 5 wt % on the basis of the total weight of the molten salt bath.

In aspect (27), in the method of any of aspects (1) through (26), the method further comprises contacting a glass-based substrate with the molten salt bath to produce an ion exchanged glass-based article, wherein the surface of the ion exchanged glass-based article comprises a higher concentration of sodium than the interior of the glass-based substrate.

In aspect (28), in the method of any of aspects (1) through (27), the method further comprises, after removing, using the glass-based bath regenerating material as lithium-containing cullet as an ingredient in a glass melt used to create a lithium-containing glass composition.

In aspect (29), in the method of any of aspects (1) through (27), the method further comprises after removing, extracting lithium from the glass-based bath regenerating material.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A is a plot of LiNO₃ concentration over time of two lithium-poisoned salt baths being regenerated by a glass-based bath-regenerating material composition.

FIG. 1B is a plot of NaNO₃ and KNO₃ concentration over time of two lithium-poisoned salt baths being regenerated by a glass-based bath-regenerating material composition.

FIG. 2A is a plot of LiNO₃ concentration over time of a lithium-poisoned salt bath being regenerated by a glass-based bath-regenerating material composition.

FIG. 2B is a plot of NaNO₃ and KNO₃ concentration over time of a lithium-poisoned salt bath being regenerated by a glass-based bath-regenerating material composition.

FIG. 3 shows the results of XRD analysis of one of the example Compositions after it was used to regenerate a molten salt bath.

### DETAILED DESCRIPTION

Reference will now be made in detail to methods of regenerating lithium-poisoned molten salt baths, and the glass-based materials used in such processes, according to various embodiments. The method includes contacting a sodium-containing glass-based material with the lithium-poisoned molten salt bath such that lithium ions are exchanged out of the molten salt bath and into the glass-based material.

As used herein, “glass-based” refers to glass or glass ceramic. Unless context dictates otherwise, a glass-based “article” is used to refer to the product created by ion exchange, usually a consumer product. A molten salt bath is used to exchange Na and/or K ions from the bath into the glass-based article in exchange for Li ions that move from the article into the bath, to create a stress profile. A glass-based “bath-regenerating” material refers to a material used to address lithium poisoning in the molten salt bath, for example after such a bath has been used for ion exchange as described. The glass-based “bath-regenerating” material extracts Li ions from the bath. While this may result in a stress profile in the glass-based bath-regenerating material, it is not a commercially desirable stress profile. The glass-based bath-regenerating material, once it has extracted Li ions from a molten salt bath, may then be further processed as an ingredient for a glass melt to make Li-containing glasses, or to extract Li from the glass-based bath-regenerating material for general usage.

In embodiments of glass-based bath-regenerating material compositions described herein, the concentration of constituent components (e.g., SiO₂, Al₂O₃, K₂O, and the like) are given in mole percent (mol %) on an oxide basis, unless otherwise specified. Components of the glass-based bath-regenerating material composition according to embodiments are discussed individually below. It should be understood that any of the variously recited ranges of one component may be individually combined with any of the variously recited ranges for any other component. As used herein, a trailing 0 in a number is intended to represent a significant digit for that number. For example, the number “1.0” includes two significant digits, and the number “1.00” includes three significant digits.

Unless otherwise specified, components of a molten salt bath are given in weight percent (wt %).

Providing glass-based composition in mol % and bath composition in wt % is consistent with certain industry practices and the measurement techniques used herein. The composition of glass-based materials is often provided in mol %. And, the composition of a molten salt bath is often provided in wt %. Unless otherwise specified, glass compositions for glass-based bath-regenerating material prior to use in regenerating a bath is measured by x-ray fluorescence (XRF). After regenerating, unless otherwise specified, composition is measured by Inductively Coupled Plasma Mass Spectroscopy (ICP-MS) and electron microprobe (EDS), where ICP-MS, and more specifically Inductively Coupled Plasma Flame Emission Spectra (ICP-FES) is used to measure the lithium content. The bath composition (nitrate salts) was measured by sampling aliquots of fluids at specific points in time, which were then measured using Ion Chromatography (IC).

In embodiments, the glass-based bath-regenerating material can be used as a cullet or powder form to capture the lithium ions in a molten salt and obtain a stable chemistry in the glass. After exchanging lithium ions out of the molten salt bath and into the glass-based bath-regenerating material, the cullet or powder can be easily retracted from the salt bath and used as a source of lithium for glass melting or lithium extraction.

The regeneration methods described herein operate by removing lithium poisoning ions from the molten salt bath. A molten salt bath containing lithium poisoning ions may be referred to as a poisoned salt bath. The lithium poisoning ions are present in the molten salt bath as the result of utilizing the molten salt bath to chemically strengthen glass or glass-ceramic articles, such as by exchanging sodium and/or potassium ions from the bath for lithium ions in the articles. The accumulation of the lithium poisoning ions in the bath changes the composition of the bath over time and may change the compressive stress profile imparted to the chemically strengthened glass or glass ceramic articles. To maintain the effectiveness of the molten salt bath it may be periodically regenerated by removing lithium poisoning ions from the molten salt bath. The regeneration may also include the addition of desired ions, such as sodium and/or potassium, to the molten salt bath to replace such ions that are depleted from the molten salt bath by ion exchange.

The use of Na₂O-containing bath-regenerating glass-based materials to remove lithium poisoning ions from a bath advantageously allows the avoidance of introducing extra ions such as carbonate or phosphate. The level of undesired ions may be 0.1 wt % or lower.

Compared to lithium-poisoned bath regeneration using Na₃PO₄ (TSP or other salts), regeneration using the glass-based bath-regenerating materials described herein does not increase molten salt bath pH, i.e., the regeneration keeps the bath at neutral pH. The advantages of maintaining neutral pH include: reducing metal corrosion of the IOX tank, and IOX fixtures, and minimizing glass surface cosmetic defects that occur when glasses are IOX'ed in high pH molten salts.

Compared to carbonate salts, regeneration using bath-regenerating glass-based materials can help minimize the appearance of surface defects on post IOX glass surface. Carbonate salts can form Li₂CO₃ crystals inside a lithium containing bath. These Li₂CO₃ crystals can attach to glass surface and have solid-solid reaction with glass surface inside high temperature salt bath. The relevant reaction is below:

Li₂CO₃+SiO₂=>Li₂SiO₃+CO₂

Such a reaction can make the glass surface rough and appear hazy. When regeneration is done with glasses instead of carbonate salts, the post-IOX glass surface would have no such defects.

The molten salt bath may have any appropriate composition for ion exchange. In embodiments, the molten salt bath may be a nitrate bath, such as a potassium nitrate (KNO₃) bath, a sodium nitrate (NaNO₃) bath, or combinations thereof. The molten salt bath may also contain additives, such as silicic acid.

The glass-based bath-regenerating materials described herein, both before and after extracting lithium from a molten salt bath, are environmentally friendly. After extracting lithium from a molten salt bath, the glass-based bath-regenerating material can be recycled to by using it as direct input as cullet into glass manufacturing, or extracting the lithium from the glass-based material for general use, in glass manufacturing or elsewhere.

The glass-based bath-regenerating materials described herein can be in different formats: powders, chunks or other shape. When in non-powder shape, which is preferred, there will be no sludge issue (solid layer at the tank bottom) which makes it very convenient for tank cleaning. Larger size glass particles, for example greater than or equal to 50 μm to less than or equal to 5 mm and various subranges described herein, also known as “cullet,” are potentially easier to separate from molten salt with less salt drag-out.

In embodiments, sodium-containing glass-based bath-regenerating material compositions are provided that can be used to absorb poisoning lithium ions in a molten salt bath for regeneration purposes. Example compositions are listed in Table 1. In embodiments, to decrease the concentration of poisoning lithium ion in a salt bath, a group of Na₂O-containing glass compositions from silicate or phosphate families can be used. The sodium-containing compositions comprise, as represented in molar percentage,
30 to 85% SiO₂,
2 to 20% Al₂O₃,
10 to 60% Na₂O,
0 to 3% K₂O,
0-10% MgO,
0-10% CaO,
0-10% SrO

Other components may be present, as described in further detail herein.

In embodiments, the compositions provided are compatible with traditional melting tanks and can be melted at temperatures below 1500° C. Glass cullet can be produced by quenching the glass melt in distilled water. The particle size can be further reduced and classified through mechanical milling, including air jet mill, ball mill or attrition mill, depending on the particle size desired.

The bath-regenerating glass-based materials described herein can have high melting temperature capability and low solubility in common molten salt bath (such as nitrate salt bath). Low solubility will help keep the purity and quality of molten salt bath quality, and can further improve the quality of chemically strengthened glass articles. In comparison, when using Na₃PO₄ (TSP) to regenerate lithium poisoned molten nitrate salt bath at temperatures close or above 500 C, PO₄ ions commonly left inside molten salt bath. Even though the concentration of PO₄ ions is small, they can still react with glass and glass-ceramic surfaces and generate defects. Using the glass-based bath-regenerating materials described herein to regenerate a molten salt bath will not lead to these undesirable contamination issues.

The regeneration method includes contacting the bath-regenerating glass-based material with the lithium poisoned salt bath, such that after the contacting the concentration of the lithium poisoning ions in the molten salt bath is less than the concentration prior to the contacting. The bath-regenerating glass-based material has a composition that will allow the poisoning ions to exchange from the bath into the bath-regenerating glass-based material, reducing the concentration of lithium poisoning ions in the molten salt bath. The exchange of the lithium poisoning ions into the bath-regenerating glass-based material may be accompanied by the exchange of ions from the bath-regenerating glass-based material into the bath, and these released ions may of a type desired in the bath. By way of example, a sodium-containing glass-based material may be contacted with a lithium-poisoned sodium nitrate and/or potassium nitrate bath such that the lithium ions from the bath exchange into the glass articles and sodium and/or potassium ions exchange out of the glass articles into the bath.

One highly desirable type of ion-exchange involves using a mixed bath of sodium nitrate and potassium nitrate to create a two-slope stress profile in a glass-based article. Sodium ions are smaller and more mobile than potassium ions in certain glass compositions. In this type of ion exchange, both sodium and potassium exchange from a molten salt bath into a lithium-containing glass article, in exchange for lithium coming out of the article. Compared with potassium, the smaller sodium ion exchanges with lithium ions in the glass-based article more quickly, and diffuses to a relatively greater depth in the glass-based article. As such, the sodium creates a part of the stress profile that extends relatively deeply into the glass, with a relatively low slope. Compared to sodium, potassium ions exchange with lithium ions in the glass-based article more slowly, and diffuse to a relatively shallow depth in the glass-based article. The larger size of the potassium ions, and their concentration relatively close to the glass surface, creates a “surface spike” in the stress profile that is near the surface of the glass-based article, with a relatively high slope. This type of ion-exchange depletes both sodium and potassium from the molten salt bath, and also poisons the bath with lithium ions. In a preferred embodiment, regenerating the molten salt bath with the glass-based materials described herein involves not only extracting lithium from the bath but also replacing the sodium and potassium in the bath depleted by ion exchange, while minimizing any changes from the original molten salt bath composition. So, for the highly desirable type of ion exchange process described here, it is desirable to exchange mostly sodium out of the glass-based material in exchange for lithium from the molten-salt bath, while also minimizing uptake of potassium from the bath or ideally also exchanging some potassium into the bath. However, so long as lithium poisoning ions are removed, if the regenerating process results in a bath composition that is out of spec with respect to the amount of sodium or potassium in the bath, additional sodium or potassium may be added to compensate.

Minimizing uptake of potassium from the bath or ideally also exchanging some potassium into the bath is a challenge that is met by some embodiments described herein, including Examples 7-12. Older ion exchange processes, before the use of lithium-containing cover-glass articles, involved exchanging sodium out of the glass in exchange for larger potassium ions from the molten salt bath. The glass-based materials described herein are sodium-containing, and the molten salt bath contains potassium. So, there is a tendency for sodium in the glass-based material to exchange with potassium from the molten salt bath. However, the inventors have discovered that using a particular range of compositions for the glass-based bath-regenerating materials, consistent with examples 7-12, can minimize potassium uptake from the molten salt bath.

By way of example, a sodium-containing bath-regenerating glass-based material may be contacted with a lithium-poisoned sodium nitrate and/or potassium nitrate bath such that the lithium ions from the bath exchange into the glass articles and sodium and/or potassium ions exchange out of the glass articles into the bath.

In embodiments, an efficient lithium extraction can be achieved using cullet produced from compositions described herein. For example, in Example 1, the concentration of LiNO₃ decreased by more than half, from 1% to less than 0.5%, after 2 wt % of Composition 1 or Composition 2 was added to a lithium-poisoned bath for 24 hours. Further reductions can be achieved by using more cullet.

The regeneration methods may be applied to any molten salt bath in which lithium poisoning ions are present at an undesired level. In embodiments, prior to contacting the molten salt bath with the plurality of glass articles the lithium poisoning ion may be present in the molten salt bath in an amount of greater than or equal to 0.1 wt %, such as greater than or equal to 0.2 wt %, greater than or equal to 0.3 wt %, greater than or equal to 0.4 wt %, greater than or equal to 0.5 wt %, greater than or equal to 0.6 wt %, greater than or equal to 0.7 wt %, greater than or equal to 0.8 wt %, greater than or equal to 0.9 wt %, greater than or equal to 1.0 wt %, greater than or equal to 1.1 wt %, greater than or equal to 1.2 wt %, greater than or equal to 1.3 wt %, greater than or equal to 1.4 wt %, greater than or equal to 1.5 wt %, greater than or equal to 1.6 wt %, greater than or equal to 1.7 wt %, greater than or equal to 1.8 wt %, greater than or equal to 1.9 wt %, greater than or equal to 2.0 wt %, greater than or equal to 2.1 wt %, greater than or equal to 2.2 wt %, greater than or equal to 2.3 wt %, greater than or equal to 2.4 wt %, greater than or equal to 2.5 wt %, greater than or equal to 2.6 wt %, greater than or equal to 2.7 wt %, greater than or equal to 2.8 wt %, greater than or equal to 2.9 wt %, greater than or equal to 3.0 wt %, greater than or equal to 3.1 wt %, greater than or equal to 3.2 wt %, greater than or equal to 3.3 wt %, greater than or equal to 3.4 wt %, greater than or equal to 3.5 wt %, greater than or equal to 3.6 wt %, greater than or equal to 3.7 wt %, greater than or equal to 3.8 wt %, greater than or equal to 3.9 wt %, greater than or equal to 4.0 wt %, greater than or equal to 4.1 wt %, greater than or equal to 4.2 wt %, greater than or equal to 4.3 wt %, greater than or equal to 4.4 wt %, greater than or equal to 4.5 wt %, greater than or equal to 4.6 wt %, greater than or equal to 4.7 wt %, greater than or equal to 4.8 wt %, greater than or equal to 4.9 wt %, or more. In embodiments, prior to regeneration the molten salt bath contains the poisoning ion in an amount from greater than or equal to 0.1 wt % to less than or equal to 5.0 wt %, such as from greater than or equal to 0.2 wt % to less than or equal to 4.9 wt %, from greater than or equal to 0.3 wt % to less than or equal to 4.8 wt %, from greater than or equal to 0.4 wt % to less than or equal to 4.7 wt %, from greater than or equal to 0.5 wt % to less than or equal to 4.6 wt %, from greater than or equal to 0.6 wt % to less than or equal to 4.5 wt %, from greater than or equal to 0.7 wt % to less than or equal to 4.4 wt %, from greater than or equal to 0.8 wt % to less than or equal to 4.3 wt %, from greater than or equal to 0.9 wt % to less than or equal to 4.2 wt %, from greater than or equal to 1.0 wt % to less than or equal to 4.1 wt %, from greater than or equal to 1.1 wt % to less than or equal to 4.0 wt %, from greater than or equal to 1.2 wt % to less than or equal to 3.9 wt %, from greater than or equal to 1.3 wt % to less than or equal to 3.8 wt %, from greater than or equal to 1.4 wt % to less than or equal to 3.7 wt %, from greater than or equal to 1.5 wt % to less than or equal to 3.6 wt %, from greater than or equal to 1.6 wt % to less than or equal to 3.5 wt %, from greater than or equal to 1.7 wt % to less than or equal to 3.4 wt %, from greater than or equal to 1.8 wt % to less than or equal to 3.3 wt %, from greater than or equal to 1.9 wt % to less than or equal to 3.2 wt %, from greater than or equal to 2.0 wt % to less than or equal to 3.1 wt %, from greater than or equal to 2.1 wt % to less than or equal to 3.0 wt %, from greater than or equal to 2.2 wt % to less than or equal to 2.9 wt %, from greater than or equal to 2.3 wt % to less than or equal to 2.8 wt %, from greater than or equal to 2.4 wt % to less than or equal to 2.7 wt %, from greater than or equal to 2.5 wt % to less than or equal to 2.6 wt %, and any and all sub-ranges formed from any of these endpoints. A particularly desired range for the lithium content of a molten salt bath for certain ion exchange processes, such as those involving many generations of Gorilla glass, is greater than or equal to 0.1 wt %, and less than or equal to 1.0 wt %. Greater than or equal to 0.1 wt % is desirable because a small amount of lithium “spiking” in the bath prior to ion exchange is desirable to avoid the significant differences in stress profile that might occur between the first batch of cover glass processed in a completely lithium-free bath, and subsequent batches where lithium poisoning ions are present in the bath. In the range between and including 0.1 wt % 1.0 wt % lithium, the stress profiles obtained are relatively consistent. At greater than 1.0 wt % lithium, issues such as surface defects or sub-optimal stress profiles begin to occur in the glass-based articles. A this point, the bath is undesirable to use to create an ion-exchanged premium product unless it is regenerated to remove the poisoning ion.

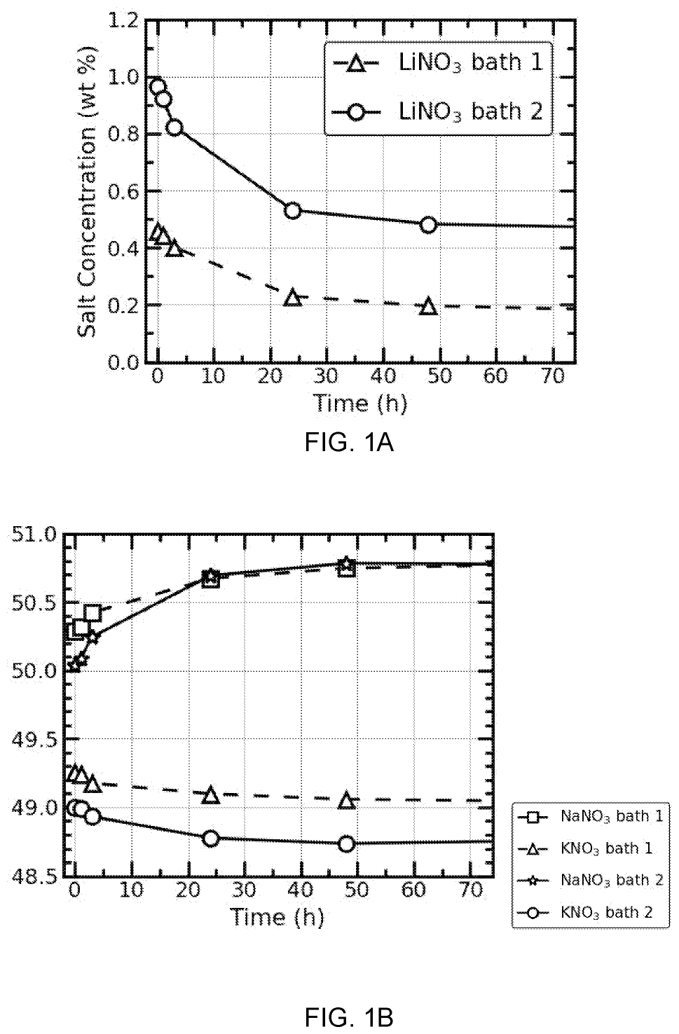

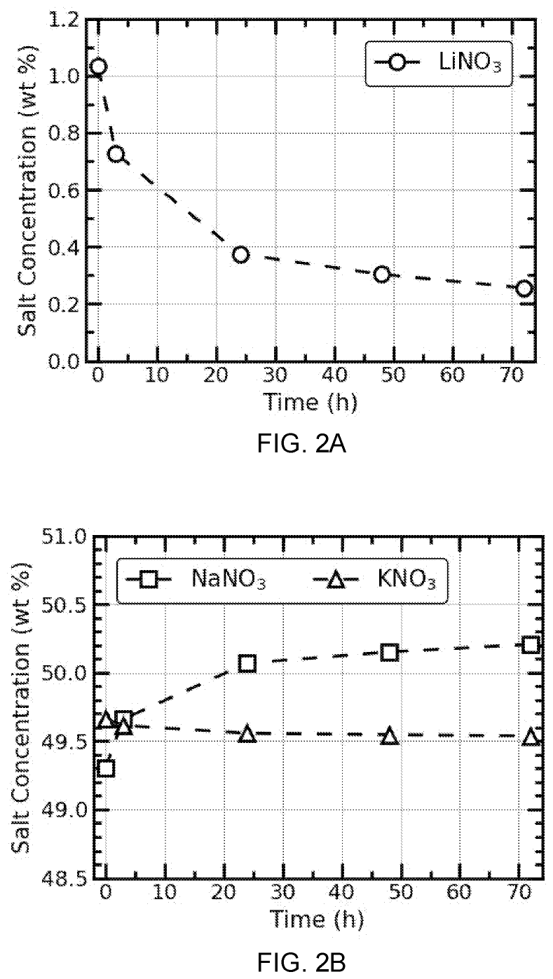

The contacting of the plurality of glass articles with the poisoned salt bath may extend for any appropriate period. The contacting time period may be selected based on the concentration of the lithium poisoning ion in the molten salt bath, the desired reduction in the concentration of the lithium poisoning ion, and the total mass and particle size of the glass-based material contacted with the lithium poisoned molten salt bath. In order to maintain process efficiency, it is desirable to select a time period that corresponds to a relatively high level of lithium uptake into the glass-based material, and to remove the glass-based article from the molten salt bath before the “tail” in lithium uptake. However, there is little downside to leaving the glass-based material in the molten salt bath during this tail, it is just less efficient. In embodiments, the contacting time may extend for a period of from greater than or equal to 0.5 hours to less than or equal to 72 hours, preferably 0.5 hours to less than or equal to 24 hours, such as from greater than or equal to 1 hours to less than or equal to 23 hours, from greater than or equal to 2 hours to less than or equal to 22 hours, from greater than or equal to 3 hours to less than or equal to 21 hours, from greater than or equal to 4 hours to less than or equal to 20 hours, from greater than or equal to 5 hours to less than or equal to 19 hours, from greater than or equal to 6 hours to less than or equal to 18 hours, from greater than or equal to 7 hours to less than or equal to 17 hours, from greater than or equal to 8 hours to less than or equal to 16 hours, from greater than or equal to 9 hours to less than or equal to 15 hours, from greater than or equal to 10 hours to less than or equal to 14 hours, from greater than or equal to 11 hours to less than or equal to 13 hours, from greater than or equal to 10 hours to less than or equal to 12 hours, and any and all sub-ranges formed from any of the these endpoints. As can be seen from FIGS. 1A, 1B, 2A and 2B, times described above that are equal to or less than 24 hours are preferred, because after 24 hours the rate of transfer of lithium from the bath into the glass-based bath-regenerating material is reduced. However, as one of skill in the art can appreciate from the disclosure contained here, this time period may change depending upon factors such as lithium content in the bath, temperature, and the particle size and amount of glass-based bath-regenerating used.

The regeneration method reduces the concentration of the lithium poisoning ions in the molten salt bath to a desired level. In embodiments, after regeneration, the molten salt bath contains lithium poisoning ion in an amount of less than or equal to 70% of the concentration of the poisoning ion prior to regeneration, such as less than or equal to 65%, less than or equal to 60%, less than or equal to 55%, less than or equal to 50%, less than or equal to 45%, less than or equal to 40%, less than or equal to 35%, less than or equal to 30%, less than or equal to 25%, less than or equal to 20%, less than or equal to 15%, or less than or equal to 10% of the concentration of the poisoning ion prior to regeneration. In some embodiments, it is desirable to not remove all of the lithium from the molten salt bath, and to retain 0.1% total Li ions as a percentage of ions in the bath.

The molten salt bath may be at any appropriate temperature during the regeneration method. For example, the molten salt bath may be maintained at the same temperature as when the bath is utilized to chemically strengthen glass articles. The temperature of the molten salt bath may also be adjusted to a temperature that facilitates efficient exchange of the poisoning ions into the plurality of glass articles from the bath prior to the beginning of the regeneration process. In embodiments, the molten salt bath may have a temperature in the range from greater than or equal to 350° C. to less than or equal to 550° C., such as greater than or equal to 360 ºC to less than or equal to 540° C., greater than or equal to 370° C. to less than or equal to 530° C., greater than or equal to 380° ° C. to less than or equal to 520° C., greater than or equal to 390° C. to less than or equal to 510° C., greater than or equal to 400° C. to less than or equal to 500° C., greater than or equal to 410° C. to less than or equal to 490° C., greater than or equal to 420° C. to less than or equal to 480° C., greater than or equal to 430° C. to less than or equal to 470° C., greater than or equal to 440° C. to less than or equal to 460° C., greater than or equal to 350° C. to less than or equal to 450° C., and any and all sub-ranges formed from any of the these endpoints. In a preferred embodiment, the molten salt bath is maintained at the same temperature as when the bath is utilized to chemically strengthen glass articles. Indeed, the regeneration method may be practiced while the bath is being used for ion-exchange, reducing or eliminating the need to take a bath off-line for regeneration.

The amount of glass-based bath-regenerating material contacted with the lithium poisoned molten salt bath may be any appropriate amount. Utilizing a higher amount of glass-based bath-regenerating material increases the effectiveness of the regeneration process, but if the amount of glass-based bath-regenerating material is too high the cost may be prohibitively high. In addition, using too much glass-based bath-regenerating material may result in excessive drag-out, which is the undesired removal of molten salt bath when the glass-based bath-regenerating material is removed from the bath. In embodiments, the amount of glass articles contacted with the molten salt bath is greater than or equal to 0.5 wt % (on the basis of the total weight of the molten salt bath), such as greater than or equal to 1.0 wt %, greater than or equal to 1.5 wt %, greater than or equal to 2.0 wt %, greater than or equal to 2.5 wt %, greater than or equal to 3.0 wt %, greater than or equal to 3.5 wt %, greater than or equal to 4.0 wt %, greater than or equal to 4.5 wt %, or more. In embodiments, the amount of glass articles contacted with the molten salt bath is from greater than or equal to 0.5 wt % to less than or equal to 5.0 wt % (on the basis of the total weight of the molten salt bath), such as greater than or equal to 1.0 wt % to less than or equal to 4.5 mol %, greater than or equal to 1.5 wt % to less than or equal to 4.0 mol %, greater than or equal to 2.0 wt % to less than or equal to 3.5 mol %, greater than or equal to 2.5 wt % to less than or equal to 3.0 mol %, and any and all sub-ranges formed from any of the these endpoints.

The glass-based bath-regenerating material may be added to the lithium poisoned molten salt bath in any appropriate manner. In embodiments, the glass-based bath-regenerating material may be added directly to the molten salt bath. The glass-based bath-regenerating material may also be within a containment vessel during the contacting. In embodiments, the containment vessel may be a basket or other structure that may be submerged in the molten salt bath that includes openings sized to allow the molten salt bath to pass into the containment vessel while preventing the glass-based bath-regenerating material from passing through. The containment vessel may be of the type described in U.S. Patent App. Pub. No. 2020/0172434A1 titled “Apparatus and Method of Delivering Solid Chemicals and Retaining Sludge in Molten Salt Baths,” published Jun. 4, 2020, which is incorporated herein in its entirety. The glass-based bath-regenerating material may be removed from the molten salt bath after a desired time passes, or after the desired level of lithium poisoning ion concentration reduction is achieved. Alternatively, the glass-based bath-regenerating material may remain in the molten salt bath after the conclusion of the regeneration method.

The glass-based bath-regenerating material may have any appropriate geometry and size. The glass-based bath-regenerating material may be in the form of chunks or powder. In embodiments, the glass-based bath-regenerating material is in powder form and have an average particle size in the range from greater than or equal to 1 μm to less than or equal to 100 μm. glass-based bath-regenerating material in powder form may be particularly desirable when the glass-based bath-regenerating material remain in the molten salt bath after the conclusion of the regeneration method. In embodiments, the glass articles may be in chunk form and have an average particle size in the range from greater than or equal to 50 μm to less than or equal to 5 mm (5000 μm). Glass articles in chunk form may be particularly desirable when the glass articles are removed from the molten salt bath after the desired reduction in lithium poisoning ion concentration is achieved. The glass articles may have an average particle size in the range from greater than or equal to 1 μm to less than or equal to 5 mm, such as greater than or equal to 10 μm to less than or equal to 4.5 mm, greater than or equal to 20 μm to less than or equal to 4 mm, greater than or equal to 30 μm to less than or equal to 3.5 mm, greater than or equal to 40 μm to less than or equal to 3 mm, greater than or equal to 50 μm to less than or equal to 2.5 mm, greater than or equal to 60 μm to less than or equal to 2 mm, greater than or equal to 70 μm to less than or equal to 1.5 mm, greater than or equal to 80 μm to less than or equal to 1 mm, greater than or equal to 90 μm to less than or equal to 100 μm, and any and all sub-ranges formed from any of the these endpoints. Unless otherwise specified, average particle size is measured using standard sieve techniques to separate particle sizes after ball milling (for larger particles) and jet milling (for smaller particles) There is some overlap between the “powder” and “chunk” ranges, because the particle types are correlated with preferred methods of use for the particle type, i.e., remaining in the bath vs. removal. But, powders may be removed from the bath and chunks may be left in.

After the conclusion of the regeneration method (or during), the molten salt bath may be utilized to chemically strengthen glass articles. The chemical strengthening method may include contacting a glass-based article with the regenerated molten salt bath to produce an ion-exchanged glass-based article. The ion-exchanged glass-based article includes a higher concentration of sodium and a lower concentration of lithium at the surface than prior to ion exchange.

Disclosed herein are glass-based bath regenerating material compositions that may be employed to form the glass-based bath-regenerating materials utilized to regenerate lithium-poisoned molten salt baths.

In the glass-based bath regenerating material compositions disclosed herein, SiO₂ is the largest constituent and, as such, SiO₂ is the primary constituent of the glass network formed from the composition. Pure SiO₂ has a high melting point. Accordingly, if the concentration of SiO₂ in the composition is too high, the formability of the composition may be diminished as higher concentrations of SiO₂ increase the difficulty of melting the composition, which, in turn, adversely impacts the formability of the composition. In embodiments, the composition includes SiO₂ in an amount from greater than or equal to 30 mol % to less than or equal to 85 mol %, such as greater than or equal to 31 mol % to less than or equal to 85 mol %, greater than or equal to 32 mol % to less than or equal to 85 mol %, greater than or equal to 33 mol % to less than or equal to 85 mol %, greater than or equal to 34 mol % to less than or equal to 85 mol %, greater than or equal to 35 mol % to less than or equal to 85 mol %, greater than or equal to 36 mol % to less than or equal to 85 mol %, greater than or equal to 37 mol % to less than or equal to 85 mol %, greater than or equal to 38 mol % to less than or equal to 85 mol %, greater than or equal to 39 mol % to less than or equal to 85 mol %, greater than or equal to 40 mol % to less than or equal to 85 mol %, greater than or equal to 41 mol % to less than or equal to 84 mol %, greater than or equal to 42 mol % to less than or equal to 83 mol %, greater than or equal to 43 mol % to less than or equal to 82 mol %, greater than or equal to 44 mol % to less than or equal to 81 mol %, greater than or equal to 45 mol % to less than or equal to 80 mol %, greater than or equal to 46 mol % to less than or equal to 79 mol %, greater than or equal to 47 mol % to less than or equal to 78 mol %, greater than or equal to 48 mol % to less than or equal to 77 mol %, greater than or equal to 49 mol % to less than or equal to 76 mol %, greater than or equal to 50 mol % to less than or equal to 75 mol %, greater than or equal to 51 mol % to less than or equal to 74 mol %, greater than or equal to 52 mol % to less than or equal to 73 mol %, greater than or equal to 53 mol % to less than or equal to 72 mol %, greater than or equal to 54 mol % to less than or equal to 71 mol %, greater than or equal to 55 mol % to less than or equal to 70 mol %, greater than or equal to 56 mol % to less than or equal to 69 mol %, greater than or equal to 57 mol % to less than or equal to 68 mol %, greater than or equal to 58 mol % to less than or equal to 67 mol %, greater than or equal to 59 mol % to less than or equal to 66 mol %, greater than or equal to 60 mol % to less than or equal to 65 mol %, greater than or equal to 61 mol % to less than or equal to 64 mol %, greater than or equal to 62 mol % to less than or equal to 63 mol %, greater than or equal to 50 mol % to less than or equal to 60 mol %, and all ranges and sub-ranges between the foregoing values.

The glass-based bath regenerating material composition includes Al₂O₃. Al₂O₃ may serve as a glass network former, similar to SiO₂, and stabilizes the network structure of the composition. Al₂O₃ may increase the viscosity of the composition due to its tetrahedral coordination in a glass melt formed from a composition, decreasing the formability of the composition when the amount of Al₂O₃ is too high. Additionally, Al₂O₃ may increase the ion exchange diffusivity of the compositions. However, when the concentration of Al₂O₃ is balanced against the concentration of SiO₂ and the concentration of alkali oxides in the composition, Al₂O₃ can reduce the liquidus temperature of the glass melt, thereby enhancing the liquidus viscosity and improving the compatibility of the composition with certain forming processes. In embodiments, the composition includes Al₂O₃ in an amount from greater than 2 mol % to less than or equal to 20 mol %, such as from greater than or equal to 3 mol % to less than or equal to 19 mol %, from greater than or equal to 4 mol % to less than or equal to 18 mol %, from greater than or equal to 5 mol % to less than or equal to 17 mol %, from greater than or equal to 6 mol % to less than or equal to 16 mol %, from greater than or equal to 7 mol % to less than or equal to 15 mol %, from greater than or equal to 8 mol % to less than or equal to 14 mol %, from greater than or equal to 9 mol % to less than or equal to 13 mol %, from greater than or equal to 10 mol % to less than or equal to 12 mol %, from greater than or equal to 10 mol % to less than or equal to 11 mol %, from greater than or equal to 3 mol % to less than or equal to 8 mol %, and all ranges and sub-ranges between the foregoing values.

Without intending to be limited by theory, it is believed that the beneficial effect of Al₂O₃ in speeding Na diffusion occurs because Na bonds to an oxygen that is bound to aluminum relatively weakly, compared to the strength that the Na bonds to an oxygen bound to silicon. So, the beneficial effect of Al₂O₃ is capped by the amount of Na in the material. More Al₂O₃ can be present for other reasons, but there is an upper limit at which additional Al₂O₃ will no longer favorably impact Na diffusion. In embodiments, Al₂O₃ is less than or equal to Na₂O.

The glass-based bath regenerating material composition includes Na₂O. Na₂O serves as an aid in achieving low melting temperature and low liquidus temperatures. It is also a key oxide in the claimed compositions because it exchanges with poisoning lithium ion in the molten salt bath during bath regeneration. A higher Na₂O concentration favors a faster regeneration rate. However, too high Na₂O is challenging for glass melting due to its lack of glass network-forming capability. In embodiments, the composition includes Na₂O in an amount from greater than 10 mol % to less than or equal to 60 mol %, such as from greater than or equal to 11 mol % to less than or equal to 59 mol %, from greater than or equal to 12 mol % to less than or equal to 58 mol %, from greater than or equal to 13 mol % to less than or equal to 57 mol %, from greater than or equal to 14 mol % to less than or equal to 56 mol %, from greater than or equal to 15 mol % to less than or equal to 55 mol %, from greater than or equal to 16 mol % to less than or equal to 54 mol %, from greater than or equal to 17 mol % to less than or equal to 53 mol %, from greater than or equal to 18 mol % to less than or equal to 52 mol %, from greater than or equal to 19 mol % to less than or equal to 51 mol %, greater than or equal to 20 mol % to less than or equal to 50 mol %, from greater than or equal to 21 mol % to less than or equal to 49 mol %, from greater than or equal to 22 mol % to less than or equal to 48 mol %, from greater than or equal to 23 mol % to less than or equal to 47 mol %, from greater than or equal to 24 mol % to less than or equal to 46 mol %, from greater than or equal to 25 mol % to less than or equal to 45 mol %, from greater than or equal to 26 mol % to less than or equal to 44 mol %, from greater than or equal to 27 mol % to less than or equal to 43 mol %, from greater than or equal to 28 mol % to less than or equal to 42 mol %, from greater than or equal to 29 mol % to less than or equal to 41 mol %, greater than or equal to 30 mol % to less than or equal to 40 mol %, from greater than or equal to 31 mol % to less than or equal to 39 mol %, from greater than or equal to 32 mol % to less than or equal to 38 mol %, from greater than or equal to 33 mol % to less than or equal to 37 mol %, from greater than or equal to 34 mol % to less than or equal to 36 mol %, from greater than or equal to 35 mol % to less than or equal to 36 mol %, and all ranges and sub-ranges between the foregoing values.

The glass-based bath regenerating material compositions may optionally include K₂O. Where the bath contains potassium (K″) ions, the presence of K₂O in the glass-based composition may desirably inhibit the undesirable depletion of K″ ions from the bath into the glass-based bath-regenerating material. K₂O. K₂O also reduces the melting temperature and liquidus temperature of the glass compositions, improving the manufacturability thereof. If the concentration of K₂O is too high it may be difficult to form the glass due to a lack of network-forming capability. In embodiments, the composition comprises K₂O in an amount from greater than or equal to 0 mol % to less than or equal to 3.0 mol %, such as greater than or equal to 0.5 mol % to less than or equal to 2.5 mol %, greater than or equal to 1.0 mol % to less than or equal to 2.0 mol %, greater than or equal to 1.0 mol % to less than or equal to 1.5 mol %, and all ranges and sub-ranges between the foregoing values. In embodiments, the glass composition may be substantially free or free of K₂O.

The glass-based bath regenerating material composition may optionally include magnesium. The inclusion of MgO lowers the viscosity of the composition, which may enhance the formability and manufacturability of the glass. While it is not believed that there is a mechanism through which MgO actively interferes with Li uptake, it is believed that MgO adversely impacts the efficiency of the glass-based bath regenerating material composition by taking up compositional space that could be better filled by other components. So, if the concentration of MgO is too high, the regeneration efficiency may be reduced. And, MgO is relatively expensive. In embodiments, the composition comprises MgO in an amount from greater than 0 mol % to less than or equal to 10 mol %, such as from greater than or equal to 0.5 mol % to less than or equal to 9.5 mol %, from greater than or equal to 1.0 mol % to less than or equal to 9.0 mol %, from greater than or equal to 1.5 mol % to less than or equal to 8.5 mol %, from greater than or equal to 2.0 mol % to less than or equal to 8.0 mol %, from greater than or equal to 2.5 mol % to less than or equal to 7.5 mol %, from greater than or equal to 3.0 mol % to less than or equal to 7.0 mol %, from greater than or equal to 3.5 mol % to less than or equal to 6.5 mol %, from greater than or equal to 4.0 mol % to less than or equal to 6.0 mol %, from greater than or equal to 4.5 mol % to less than or equal to 5.5 mol %, from greater than or equal to 0 mol % to less than or equal to 5.0 mol %, and all ranges and sub-ranges between the foregoing values. In embodiments, the composition comprises MgO in an amount from greater than 0 mol % to less than or equal to 3.0 mol % to minimize the cost and effect of MgO. In embodiments, the glass composition may be substantially free or free of MgO.

The glass-based bath regenerating material composition may include CaO. The inclusion of CaO lowers the viscosity of the composition, which enhances the formability. If the concentration of CaO is too high, the regeneration efficiency may be reduced. In embodiments, the composition comprises CaO in an amount from greater than or equal to 0 mol % to less than or equal to 10 mol %, such as from greater than 0 mol % to less than or equal to 10 mol %, from greater than or equal to 0.5 mol % to less than or equal to 9.5 mol %, from greater than or equal to 1.0 mol % to less than or equal to 9.0 mol %, from greater than or equal to 1.5 mol % to less than or equal to 8.5 mol %, from greater than or equal to 2.0 mol % to less than or equal to 8.0 mol %, from greater than or equal to 2.5 mol % to less than or equal to 7.5 mol %, from greater than or equal to 3.0 mol % to less than or equal to 7.0 mol %, from greater than or equal to 3.5 mol % to less than or equal to 6.5 mol %, from greater than or equal to 4.0 mol % to less than or equal to 6.0 mol %, from greater than or equal to 4.5 mol % to less than or equal to 5.5 mol %, from greater than or equal to 0 mol % to less than or equal to 5.0 mol %, and all ranges and sub-ranges between the foregoing values. In embodiments, the glass composition may be substantially free or free of CaO.

The glass-based bath regenerating material compositions may include SrO. The inclusion of SrO lowers the viscosity of the composition, which enhances the formability. If the concentration of SrO is too high, the regeneration efficiency may be reduced. In embodiments, the composition comprises SrO in an amount from greater than or equal to 0 mol % to less than or equal to 10 mol %, such as from greater than 0 mol % to less than or equal to 10 mol %, from greater than or equal to 0.5 mol % to less than or equal to 9.5 mol %, from greater than or equal to 1.0 mol % to less than or equal to 9.0 mol %, from greater than or equal to 1.5 mol % to less than or equal to 8.5 mol %, from greater than or equal to 2.0 mol % to less than or equal to 8.0 mol %, from greater than or equal to 2.5 mol % to less than or equal to 7.5 mol %, from greater than or equal to 3.0 mol % to less than or equal to 7.0 mol %, from greater than or equal to 3.5 mol % to less than or equal to 6.5 mol %, from greater than or equal to 4.0 mol % to less than or equal to 6.0 mol %, from greater than or equal to 4.5 mol % to less than or equal to 5.5 mol %, from greater than or equal to 0 mol % to less than or equal to 5.0 mol %, and all ranges and sub-ranges between the foregoing values. In embodiments, the glass composition may be substantially free or free of SrO.

In embodiments, the glass-based bath regenerating material compositions may also include Li₂O. It is desirable to minimize the amount of Li₂O in the composition because the purpose of the bath-regenerating glass-based material is to remove Li from the bath. The presence of Li₂O in the bath-regenerating glass-based material prior to removing Li from the bath reduces effectiveness and needlessly increases cost. Nevertheless, the composition still works as intended even if there is some Li₂O present. In embodiments, the glass composition comprises Li₂O in an amount from greater than or equal to 0 mol % to less than or equal to 1 mol %, such as from greater than 0.2 mol % to less than or equal to 0.8 mol %, from greater than or equal to 0.4 mol % to less than or equal to 0.6 mol %, and all ranges and sub-ranges between the foregoing values. In embodiments, the glass composition is substantially free or free of Li₂O.

In embodiments, the glass-based bath regenerating material compositions may be substantially free of one or both of arsenic and antimony. In other embodiments, the composition may be free of one or both of arsenic and antimony.

In embodiments, the glass-based bath regenerating material compositions may be substantially free or free of Fe₂O₃. Iron is often present in raw materials utilized to form glass compositions, and as a result may be detectable in the glass compositions described herein even when not actively added to the glass batch.

In embodiments, the glass-based bath regenerating material compositions may be substantially free or free of any oxide not specifically recited herein. Such oxides are not needed for the composition to work as intended. Such oxides may unnecessarily drive up cost and/or interfere with the intended uses of the glass-based bath regenerating material compositions after they are used to regenerate a bath, specifically use as cullet for glass melts or use as raw material for a lithium extraction process.

The glass-based bath regenerating material compositions may be characterized by the melting temperature thereof. If the melting temperature is too high, producing the composition may be difficult and prohibitively costly. In embodiments, the compositions have a melting temperature of less than or equal to 1600° C., such as less than or equal to 1675° C., less than or equal to 1650° C., less than or equal to 1625° C., less than or equal to 1500° C., or less.

The glass-based bath regenerating material compositions may be formed into a plurality of particles or other appropriate shapes by any appropriate process. In embodiments, the compositions may be melted, such as in traditional melting tanks, and then quenching the glass melt in distilled water to produce cullet. The particle size of the cullet may be additionally reduced and/or classified by additional processing, such as mechanical milling. The milling may include air jet milling, ball milling, attrition milling, or combinations thereof.

In embodiments, potassium uptake into the glass-based bath regenerating material compositions may be minimized through use of an appropriate composition. One or more compositional choices may contribute to this goal. The inclusion of CaO and/or SrO in the composition, consistent with example Compositions 7-12, decreases the diffusivity of Na+ for K+ exchange in the salt. For example, relative to Composition 2 of Example 3, Composition 7 in Example 4 shows a significant drop in LiNO₃ increase in NaNO₃, and more stable NaNO₃ in the bath, compare FIG. 1A and FIG. 1B to FIG. 2A and FIG. 2B, suggesting the Na⁺ for Li⁺ exchange was not adversely impacted by the presence of CaO and SrO in the precursor glass. Similarly, the presence of some K₂O in the glass-based bath regenerating material compositions slows ion-exchange of K⁺ into the glass.

It is believed that SrO and CaO may be used alone or in combination to inhibit K⁺ uptake, and that SrO is six times as effective as CaO at inhibiting the uptake of K⁺ from the bath into the glass-based bath regenerating material. In embodiments, CaO+6*SrO greater than or equal to 1.0 mol %, greater than or equal to 1.5 mol %, greater than or equal to 2.0 mol %, greater than or equal to 2.5 mol %, greater than or equal to 3.0 mol %, or greater than or equal to 3.5 mol %.

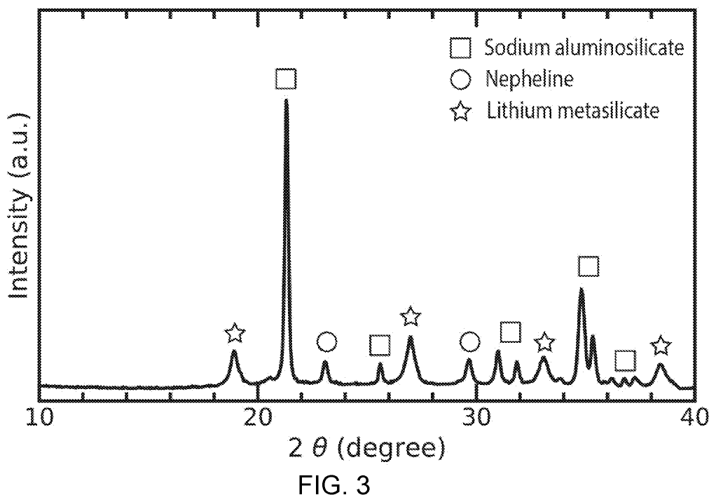

In embodiments, crystalline phases including lithium silicate form in the glass-based bath regenerating material composition after it absorbs Li ions from the bath. For example, FIG. 3 shows the presence of crystalline lithium silicate after using example Composition 7 in Example 4. It was observed that the presence of such crystalline phases correlates with a change in the visual appearance of the cullet, from transparent to opaque. It is believed that using a composition having a glass transition temperature close to that of the molten salt bath facilitates the formation of such crystalline phases. In embodiments, the bath temperature is greater than or equal to 470° C. and less than or equal to 530° C., and the glass transition temperature (Tg) of the glass-based bath regenerating material composition is also greater than or equal to 470° C. and less than or equal to 530° C., In this case, crystals can readily form in the glass-based bath regenerating material composition while the material is in the bath. At lower bath temperatures, crystals might still form, but the time frame would be undesirably long. The formation of a crystalline phases that include lithium silicate in the glass-based bath regenerating material is advantageous, because the growing crystal sequesters Li away from the glass phase of the material, enabling more and faster Li absorption. This in turn causes more positive effects, such as the ability to use less cullet relative to compositions that do not crystallize, which reduces drag-out when the cullet is removed from the bath.

It is believed that the glass transition temperatures of the Compositions disclosed herein are heavily affected by the SiO₂ and Na₂O content of the glass. In embodiments, SiO₂ is less than or equal to 50 mol %, and Na₂O is greater than or equal to 35 mol % in order to achieve a glass transition temperature in a favorable range for use with a bath having a temperature of greater than or equal to 470° C. and less than or equal to 530° C.

Without being bound by theory as to why the invention works, it is believed that when the glass-based bath regenerating material composition forms a crystalline phase, its durability increases and the likelihood decreases of pieces cleaving off from cullet to escape a container and float in the tank. This phenomena can reduce the chance of surface defects in glass-based articles that are subsequently ion-exchanged in the regenerated salt bath.

### EXAMPLES

Embodiments will be further clarified by the following examples. It should be understood that these examples are not limiting to the embodiments described above.

### Example 1

Glass compositions were prepared. The exemplary Compositions listed in Table 1 below and were prepared by conventional glass forming methods. In Table 1, all components are in mol %.

TABLE 1

| Oxide, mol % | 1 | 2 | 3 | 4 | 5 | 6 | 7 | 8 | 9 | 10 | 11 | 12 |
|---|---|---|---|---|---|---|---|---|---|---|---|---|
| SiO₂ | 56.5 | 65.3 | 47.7 | 82.9 | 74.1 | 34.5 | 49.78 | 48.17 | 46.00 | 46.82 | 46.33 | 46.23 |
| Al₂O₃ | 9.9 | 7.7 | 12.1 | 3.3 | 5.5 | 15.4 | 11.95 | 11.21 | 10.53 | 11.63 | 11.85 | 11.66 |
| Na₂O | 33.6 | 27 | 40.2 | 13.8 | 20.4 | 50.1 | 36.42 | 37.00 | 37.83 | 40.48 | 38.06 | 38.33 |
| CaO | 0 | 0 | 0 | 0 | 0 | 0 | 1.85 | 3.62 | 5.64 | 0.02 | 0.03 | 1.81 |
| SrO | 0 | 0 | 0 | 0 | 0 | 0 | 0.00 | 0.00 | 0.00 | 1.05 | 3.73 | 1.97 |
| T_{g} | 496 | 509 | 481 | 537 | 532 | 386 | 520 | 505 | 499 | 500 | 504 | 502 |
| Appearance | Tr | Tr | Tr | — | — | — | Op | Op | Op | Op | Op | Op |

T_{g} for exemplary Compositions 1 through 6 were predicted using modeling techniques. T_{g} for exemplary Compositions 7 through 12 was measured. Exemplary Compositions 1 through 3 were observed to be transparent after absorbing lithium, indicating that significant crystalline phase had not formed. Exemplary Compositions 7 through 12 were observed to be opaque after absorbing lithium, indicating that significant crystalline phase had formed. Because this crystalline formation was surprising and unexpected, x-ray diffraction analysis similar to that shown in FIG. 3 was performed on each sample to confirm the presence of lithium-containing crystal phase.

### Example 2

Cullet was prepared using Composition 2. Two separate molten salt baths were prepared. Both baths started as 50KNO₃/50NaNO₃. 0.5 wt % Li NO₃ was added to one bath, and 1.0% LiNO₃ to the other, to simulate lithium poisoning. The cullet, in an amount of 2 wt % based on the total weight of the molten salt bath, we immersed in each bath at 500° C. for 5 days. ICP and flame emission were used to determine the composition of the reacted glass cullet. Table 2 shows the composition of the cullet after such immersion.

TABLE 2

| Sample ID | SiO₂ | Al₂O₃ | K₂O | Na₂O | Li₂O |
|---|---|---|---|---|---|
| Composition 2 in | 65.81 | 7.57 | 2.63 | 18.02 | 5.38 |
| 50Na/50K/0.5Li bath | | | | | |
| 500° C., 5 days | | | | | |
| Composition 2 in | 66.73 | 7.67 | 2.64 | 16.17 | 7.68 |
| 50Na/50K/1.0Li bath | | | | | |
| 500° C., 5 days | | | | | |

As is common in the industry, the bath compositions are provided in wt %, and the numbers do not add up to 100%. 50Na (or NaNO₃)/50K (or KNO₃) means that the initial bath composition, prior to additives, is 50/50 of the two main components. Then additives such as Li (or LiNO₃) and silicic acid are added. While the amount of Na and K go down slightly as a result of adding these additives, such that adding 1 wt % LiNO₃ most accurately results in 49.5 wt % NaNO₃/49.5 wt % KNO₃/1 wt % LiNO₃, it is common to describe the ratio as 50/50/1 instead of 49.5/49.5/1. Cullet was prepared using Composition 2. Two separate molten salt baths were prepared. Both baths started as 50KNO₃/50NaNO₃. 0.5 wt % Li NO₃ was added to one bath, and 1.0% LiNO₃ to the other, to simulate lithium poisoning. The cullet, in an amount of 2 wt % based on the total weight of the molten salt bath, we immersed in each bath at 500° C. for 5 days. ICP and flame emission were used to determine the composition of the reacted glass cullet. Table 2 shows the composition of the cullet after such immersion.

### Example 3

Cullet was prepared using Composition 2. Two separate molten salt baths were prepared. Both baths started as 50% KNO₃/50% NaNO₃. 0.5% silicic acid and 0.5% LiNO₃ were added to bath 1. 0.5% silicic acid and 1.0% LiNO₃ were added to bath 2. While the baths were maintained at 500° C., cullet was added to the baths, in an amount of 2 wt % of the bath. The glass cullet was kept in the bath during the regeneration process and then removed once the extraction was completed. Small amounts of bath were extracted and analyzed for LiNO₃, NaNO₃ and KNO₃ content at the points in time reported in FIG. 1A and FIG. 1B. FIG. 1A shows a decrease in wt % of LiNO₃ in the baths over time. FIG. 1B shows an increase in wt % of NaNO₃ in the baths over time, and a decrease in wt % of KNO₃ in the baths over time.

In Example 3, lithium nitrate concentration in the bath decreases, which is desirable and is also the most basic goal of the bath regeneration process. Sodium nitrate concentration desirably increases, but potassium nitrate concentration undesirably decreases. This shows that Nat is coming out the glass in exchange for both Li+ and K+ in the bath going into the glass. The change of sodium nitrate or potassium nitrate was due to Na+ for K+ ion exchange. The regeneration process still works because poisoning Li+ is removed from the bath. But, is not ideal because desirable K+ is also removed from the bath and should be replenished by other means if the ratio of Na+ to K+ is to be maintained.

### Example 4

Cullet was prepared using Composition 7. A molten salt bath was prepared. The bath started as 50% KNO₃/50% NaNO₃. 0.5% silicic acid and 1.0% LiNO₃ were added to the bath. While the baths were maintained at 500° C., cullet was added to the bath, in an amount of 2 wt % of the bath. The glass cullet was kept in the bath during the regeneration process and then removed once the extraction was completed. Small amounts of bath were extracted and analyzed for LiNO₃, NaNO₃ and KNO₃ content at the points in time reported in FIG. 2A and FIG. 2B. FIG. 2A shows a decrease in wt % of LiNO₃ in the bath over time. FIG. 1B shows an increase in wt % of NaNO₃ in the bath over time, and a relatively constant wt % of KNO₃ in the bath over time.

In Example 4, as with Example 3, lithium nitrate concentration in the bath desirably decreases and sodium nitrate concentration desirably increases. But, Example 4 is different from Example 3 in that the potassium nitrate concentration in Example 4 remains relatively constant or at worse decreases only a small amount. This shows that Composition 7, relative to Composition 2, inhibits potassium uptake from the bath into Composition 7. Example 4 is unexpectedly superior to Example 2, because it decreases the need to replenish potassium in the bath by other means.

### Example 5

The cullet of Example 4 was removed from the bath of Example 4 after 72 hours at 500° ° C. The composition of the cullet was analyzed using X-Ray Diffraction (XRD). FIG. 3 shows the result of XRD analysis.

All glass-based material compositional components, relationships, and ratios described in this specification are provided in mol % unless otherwise stated. All ranges disclosed in this specification include any and all ranges and subranges encompassed by the broadly disclosed ranges whether or not explicitly stated before or after a range is disclosed.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method, comprising:
contacting a glass-based bath regenerating material with a molten salt bath, wherein:
prior to contacting, the glass-based bath regenerating material comprises:
greater than or equal to 30.0 mol. % and less than or equal to 85.0 mol. % SiO₂;
greater than or equal to 2.0 mol. % and less than or equal to 20.0 mol. % Al₂O₃;
greater than or equal to 10.0 mol. and less than or equal to 60.0 mol. % Na₂O;
greater than or equal to 0.0 mol. % and less than or equal to 3.0 mol. % K₂O;
greater than or equal to 0.0 mol. % and less than or equal to 10.0 mol. % MgO;
greater than or equal to 0.0 mol. % and less than or equal to 10.0 mol. % CaO; and
greater than or equal to 0.0 mol. % and less than or equal to 10.0 mol. % SrO; and
the molten salt bath comprises poisoning ions, the poisoning ions comprising lithium ions;
waiting a period of time during which the first glass-based article is in contact with the molten salt bath;
after waiting the period of time, removing the glass-based bath regenerating material from the molten salt bath;
wherein:
after removing, the concentration of poisoning ions in the molten salt bath is less than the concentration prior to the contacting and the composition of the glass-based bath regenerating material has a higher amount of Li₂O than prior to contacting.

2. The method of claim 1, wherein prior to contacting, the glass-based bath regenerating material comprises CaO+6*SrO greater than or equal to 1.0 mol %.

3. The method of claim 2, wherein prior to contacting, the glass-based bath regenerating material comprises CaO+6*SrO greater than or equal to 1.5 mol %.

4. The method of claim 3, wherein prior to contacting, the glass-based bath regenerating material comprises CaO+6*SrO greater than or equal to 5.0 mol %.

5. The method of claim 1, wherein prior to contacting, the glass-based bath regenerating material comprises Li₂O less than or equal to 1 mol %.

6. The method of claim 1, wherein prior to contacting, the glass-based bath regenerating material comprises MgO less than or equal to 3 mol %.

7. The method of claim 1, wherein prior to contacting, glass-based bath regenerating material comprises SiO₂ less than or equal to 50 mol %.

8. The method of claim 1, wherein prior to contacting, the glass-based bath regenerating material comprises Na₂O greater than or equal to Al₂O₃.

9. The method of claim 1, wherein prior to contacting, the glass-based bath regenerating material has a glass-transition temperature Tg greater than or equal to 470° C. and less than or equal to 530° C.

10. The method of claim 1, wherein the molten salt bath comprises one or more of potassium ions and sodium ions.

11. The method of claim 1, wherein the molten salt bath comprises one or more of KNO₃ and NaNO₃.

12. The method of claim 11, wherein the molten salt bath comprises:
greater than or equal to 5.0 wt. % and less than or equal to 95.0 wt. % KNO₃, and
greater than or equal to 5.0 wt. % and less than or equal to 95.0 wt. % NaNO₃, and

13. The method of claim 12, wherein the molten salt bath comprises:
greater than or equal to 40.0 wt. % and less than or equal to 60.0 wt. % KNO₃, and
greater than or equal to 40.0 wt. % and less than or equal to 60.0 wt. % NaNO₃, and

14. The method of claim 1, wherein the period of time extends for a period of from greater than or equal to 0.5 hours to less than or equal to 30 hours.

15. The method of claim 1, wherein, after removing, the lithium poisoning ion is contained in the molten salt bath in an amount of less than or equal to 50% of the amount of the poisoning ion in the molten salt bath prior to contacting.

16. The method of claim 1, wherein the glass-based bath regenerating material comprises a plurality of particles having an average particle size from greater than or equal to 50 μm to less than or equal to 5 mm.

17. The method of claim 1, wherein during the period of time the molten salt bath has a temperature of greater than or equal to 350° C. to less than or equal to 550° C.

18. The method of claim 1, wherein the amount of glass-based bath regenerating material contacted with the molten salt bath is greater than or equal to 0.5 wt % to less than or equal to 5 wt % on the basis of the total weight of the molten salt bath.

19. The method of claim 1, further comprising, after removing, using the glass-based bath regenerating material as lithium-containing cullet as an ingredient in a glass melt used to create a lithium-containing glass composition.

20. The method of claim 1, further comprising, after removing, extracting lithium from the glass-based bath regenerating material.
